(19) United States
(12) Patent Application Publication
(10) Pub. No.: US 2024/0143563 A1
(43) Pub. Date: May 2, 2024

(54) DETECTING AND CORRECTING ERRORS IN A TRANSACTION DATABASE VIA LAYER CHECKS OF MULTI-LAYERED ACCOUNTS

(71) Applicant: Marqeta, Inc., Oakland, CA (US)

(72) Inventors: Daniel Osburn, Miami, FL (US); Mohammed Amleh, Cary, NC (US)

(21) Appl. No.: 18/050,271

(22) Filed: Oct. 27, 2022

(51) Int. Cl. G06F 16/215; G06F 16/21; G06F 16/23

(52) U.S. Cl. CPC G06F 16/215; G06F 16/213; G06F 16/2365

(57) ABSTRACT

This disclosure describes methods, non-transitory computer readable storage media, and systems that utilize layer checks to detect and correct errors in a transaction database that includes transactions associated with multi-layered payment accounts. For example, the disclosed system detects errors in a transaction database caused by erroneous database operators. Specifically, the disclosed system determines states of layers that represent different fund values associated with one or more payment accounts based on transactions in a transaction database. The disclosed system detects errors in the transactions of the transaction database by performing layer checks on the layers according to rules associated with the layers and their respective states. The disclosed system utilizes information about the detected errors and transactions in the transaction database to modify database operators associated with the transaction database.

### BACKGROUND

Increases in computing technology and availability have led to an increase in use of card-based payment transactions and electronic payment transactions to complete purchase transactions. In connection with the prevalence of electronic payment transactions, many entities (e.g., banks or other issues) have provided increased access to payment accounts (e.g., credit cards or debit cards) for consumers to use with merchants and recipient entities. Additionally, in connection with providing access to payment accounts to use in card-based payment transactions and electronic payment transactions, such entities also generate downstream records and reports based on transaction events for various data analysis tasks. Accordingly, verifying that data stored for electronic payment transactions is accurate and complete is an important aspect of performing downstream operations.

While many entities provide increased access to card-based/electronic payment transactions, conventional systems that utilize data associated with the transactions often lack secure and accurate data transmission and storage. Specifically, conventional systems utilize storage or data transfer processes that can result in significant data gaps when recording transactions (e.g., database events associated with processing electronic payment transactions). For instance, processing data between multiple devices or systems typically requires executing a database management application and/or a communication application (e.g., an application programming interface) that perform specific operations on one or more computing devices. Incorrect storage of data resulting from missing data or erroneous operators in the database management application or communication application can further result in missing or late data necessary to accurately and efficiently perform downstream tasks.

Additionally, due to the data gaps or other errors in stored/transmitted database transactions caused by database management systems and communication applications, conventional systems are also often inefficient. In particular, because the conventional systems lack processes for accurately identifying the errors and their respective causes, the conventional systems are often unable to provide accurate real-time recording/reporting associated with electronic payment transactions in downstream operations. Furthermore, conventional systems typically require manual testing, identification, and correction of database errors/causes, which can involve a significant amount of time due to the number of database transactions and the amount of code involved in database management applications and communication applications.

### SUMMARY

This disclosure describes one or more embodiments of methods, non-transitory computer readable media, and systems that solves one or more of the foregoing problems (in addition to providing other benefits). In one or more embodiments, the disclosed systems detect errors in a transaction database caused by erroneous database operators. Specifically, the disclosed systems determine states of layers that represent different fund values associated with one or more payment accounts based on transactions in a transaction database. The disclosed systems detect errors in the transactions of the transaction database by performing layer checks on the layers according to rules associated with the layers and their respective states. The disclosed systems utilize information about the detected errors and transactions in the transaction database to modify database operators associated with the transaction database. By modifying database operators based on automatically detected errors in a transaction database via layer checks, the disclosed systems provide accurate and efficient database error correction.

### BRIEF DESCRIPTION OF THE DRAWINGS

The detailed description refers to the drawings briefly described below.

FIG. 1 illustrates a block diagram of a system environment in which a database error correction system is implemented in accordance with one or more implementations.

FIG. 2 illustrates a diagram of an overview of the database error correction system detecting errors in a transaction database for modifying database operators in accordance with one or more implementations.

FIG. 3 illustrates a diagram of the database error correction system performing layer checks on layers in a transaction database to determine error causes in accordance with one or more implementations.

FIGS. 4A-4E illustrate diagrams of transaction messages and account balances in connection with an electronic payment transaction in accordance with one or more implementations.

FIGS. 5A-5B illustrate graphical user interfaces for displaying interactive reports including errors based on database transactions impacting layers of payment accounts in accordance with one or more implementations.

FIG. 6 illustrates a flowchart of a series of acts for detecting errors in database transactions and modifying database operators in accordance with one or more implementations.

FIG. 7 illustrates a block diagram of an exemplary computing device in accordance with one or more implementations.

### DETAILED DESCRIPTION

This disclosure describes one or more embodiments of a database error correction system that detects and corrects errors in a transaction database. In particular, the database error correction system determines states of layers that represent specific fund values of one or more payment accounts. For example, the database error correction system determines the layer states based on a plurality of transactions stored in a transaction database in connection with a plurality of electronic payment transactions. The database error correction system utilizes layer checks to detect one or more errors in the transaction database according to rules based on the states of one or more layers. In addition, in response to detecting errors in the transaction database, the database error correction system determines the cause of the errors and modifies database operators associated with the transaction database to fix the cause of the errors.

As mentioned, in one or more embodiments, the database error correction system determines states of layers associated with one or more payment accounts in connection with a transaction database. Specifically, the database error correction system determines a plurality of layers representing different fund values associated with one or more payment accounts. Additionally, the database error correction system determines states of the layers according to a balance of each layer of the payment account(s) according to a plurality of transactions in the transaction database.

In additional embodiments, the database error correction system detects errors in the transaction database. In particular, the database error correction system utilizes a plurality of different layer checks based on the states of layers and/or comparisons of states of layers. For example, in response to determining that one or more of the layer checks fails, the database error correction system can determine that one or more states of the layers indicate an error according to the transactions in the transaction database.

In one or more embodiments, the database error correction system determines one or more causes of errors in the transaction database. For instance, the database error correction system determines correlations between categories of transaction chains in the transaction database and error categories. To illustrate, the database error correction system can determine that certain categories of transaction chains typically cause errors in certain error categories. Accordingly, by identifying the correlations between groups of related transactions and error categories, the database error correction system can more easily determine causes of the errors.

In addition to determining the errors and/or causes of the errors, in one or more embodiments, the database error correction system also modifies one or more database operators of the transaction database. Specifically, in response to determining a cause of an error, the database error correction system modifies one or more database operators to correct the cause of the error. For example, the database error correction system utilizes correlations between groups of related transaction categories and error categories to determine that such correlations indicate specific causes in the database operators (e.g., in one or more applications that store, use, or modify transaction data in the transaction database). Accordingly, the database error correction system modifies the database operators to correct errors and prevent similar errors from occurring in the future.

The disclosed database error correction system provides a number of benefits over conventional systems. For example, the database error correction system improves the accuracy of computing systems that manage databases of transactions (e.g., database events) in connection with processing electronic payment transactions. In contrast to existing systems that utilize storage or data transfer processes that result in data gaps, the database error correction system provides automatic error detection and correction in a transaction database. Specifically, the database error correction system uses a plurality of layer checks to determine whether various states of layers of payment accounts meet requirements indicated in a plurality of rules. In response to detecting any errors in a transaction database, the database error correction system can ensure accuracy of future database events/transactions by modifying one or more database operators that cause the errors in the transaction database.

Additionally, the database error correction system improves the efficiency of computing systems that manage databases of transactions and perform additional downstream operations on the transactions. In contrast to conventional systems that lack accurate storage/data transfer processes that result in data gaps requiring significant testing and time to correct, the database error correction system provides fast and efficient error detection via a plurality of layer checks in a transaction database. In particular, by determining layer states that result in specific error categories, the database error correction system can determine correlations between the error categories and specific groups of related transaction categories, which indicate likely causes of detected errors. Accordingly, the database error correction system can more efficiently correct the errors by modifying one or more database operators that cause the detected errors.

Furthermore, the database error correction system provides an efficient graphical user interface for providing interactive analysis of transactions in a transaction database. Specifically, in contrast to conventional systems that lack flexibility in accessing and analyzing large amounts of data across different systems and devices for large quantities of data (e.g., thousands or tens of thousands of database transactions and communications), the database error correction system generates interactive reports displaying results of a plurality of layer checks on layers of one or more payment accounts. More specifically, by automatically detecting errors caused by specific groups of transactions in a transaction database via the layer checks, the database error correction system can provide interactive indications of the errors detected in the various layers. Additionally, the database error correction system can also provide interactive summaries of correlations between transaction chains and error categories prioritized according to the respective impact on the payment account(s). The improved graphical user interface allows users to quickly switch between detected errors in the layers according to the layer checks and identified correlations to determine the cause(s) of errors in database operators.

The database error correction system provides a flexible and efficient graphical user interface that combines information from a plurality of different sources (e.g., a plurality of databases, systems, or devices) and provides analysis of large quantities of data from the different sources. In contrast to conventional systems that rigidly require communicating with each source and displaying the information for each source separately, the database error correction system consolidates the information from the different sources into a set of graphical user interfaces. Specifically, the database error correction system consolidates the data and interactive results of analyzing the data related to quantifying errors in data from the data sources into a first graphical user interface and data associated with identifying causes of the errors in database operators into a second graphical user interface, with each graphical user interface being accessible via separate tabs of a single client application. Thus, the database error correction system can prevent the need to access and view data related to thousands or tens of thousands of different applications at each separate source without having an understanding of the relationships between the data at the different sources.

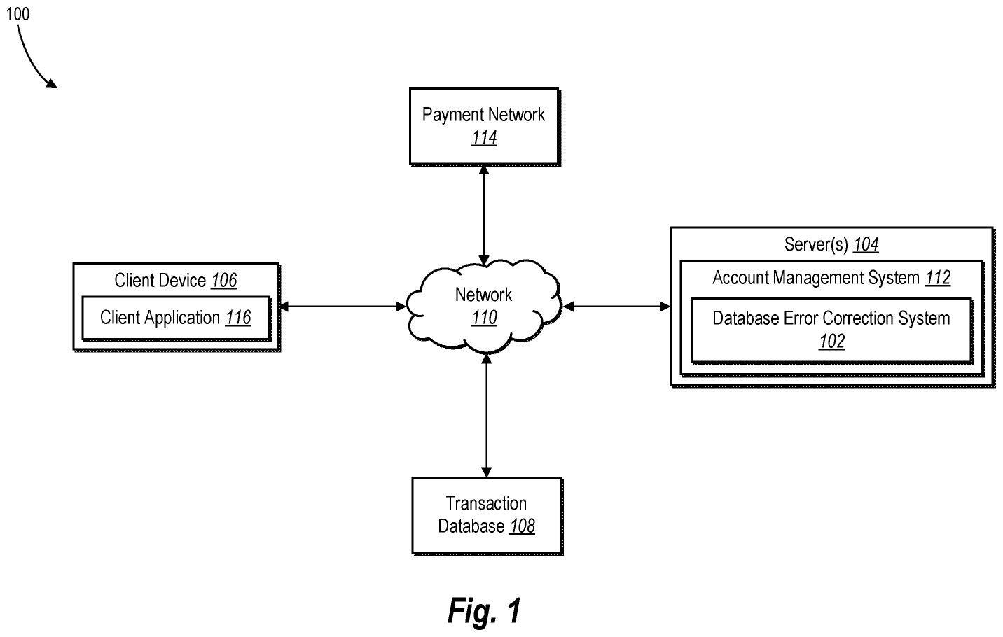

Turning now to the figures, FIG. 1 includes an embodiment of a system environment 100 in which a database error correction system 102 operates. In particular, the system environment 100 includes server(s) 104, a client device 106, and a transaction database 108 in communication via a network 110. FIG. 1 illustrates that the database error correction system 102 is part of an account management system 112. Moreover, in one or more embodiments, the system environment 100 includes a payment network 114 in communication with the server(s) 104 via the network 110. FIG. 1 also illustrates that the client device 106 includes a client application 116.

As shown in FIG. 1, the server(s) 104 include or host the account management system 112. The server(s) 104 communicate with one or more other components in the system environment 100 to manage accounts for one or more users. For example, the server(s) 104 communicates with a client device to provide account or card program management for users based on data provided/generated by the payment network 114 in connection with electronic payment transactions for one or more card/account programs. As used herein, the term “card/account program” refers to software and data that determines when and how one or more cards/accounts can be used to engage in payment transactions. For example, a card/account program includes a plurality of card/account parameter configurations that define attributes of a card/account associated with the card/account program including, but not limited to, pricing (e.g., annual percentage rate), fees, usage locations, rewards, discounts, or other attributes. Accordingly, different card programs that have different card/account parameter configurations provide different usage, benefits, etc., to users of cards/accounts corresponding to the different card/account programs.

Furthermore, as used herein, the term “payment account” refers to transaction funding account for funding electronic payment transactions. In one or more embodiments, a payment account is a payment card account or a non-card-based payment account associated with a card/account program. A card/account program can include one or more payment accounts associated with one or more users for using cards/accounts to initiate electronic payment transactions. In additional embodiments, each payment account includes a plurality of layers representing different fund values associated with the payment account, including, but not limited to, funds not yet available, funds authorized but not settled, funds available for spending, amount of overdraft, rewards values, pending credits, Just-In-Time pending loans (e.g., authorized but temporarily held funds), ACH origination, etc. Furthermore, a given payment account can be associated with one or more particular currencies (e.g., US dollars, Canadian dollars) with each currency associated with a separate subset of layers.

As used herein, a “card” refers to a physical or digital object corresponding to a payment account for engaging in card-based payment transactions. For instance, a card includes a physical credit card or a digital credit card (e.g., in a digital wallet) tied to a payment account (e.g., a payment account) via a credit card number that allows a user to initiate a payment transaction to transfer funds from the payment account to a recipient account (e.g., a merchant account) via the payment network 114. In one or more embodiments, the payment network 114 includes one or more payment gateway systems, one or more card networks (e.g., VISA, MASTERCARD), and/or one or more card issuer systems (e.g., bank issuers) to process electronic payment transactions in connection with the account management system 112. Alternatively, the payment network 114 processes non-card-based electronic payment transactions, such as ACH credit transfers or ACH debit payments according to payment account numbers.

Additionally, as used herein, the term “electronic payment transaction” refers to a payment transaction in which an payment account funds a payment from a user to a recipient. To illustrate, an electronic payment transaction includes a payment transaction involving the use of a physical card or a digital card. For instance, an electronic payment transaction includes a payment transaction via a point-of-sale device or via a mobile application or online application between an payment account of a user and a recipient account associated with a recipient (e.g., another user or a merchant system) in a peer-to-peer transaction or a peer-to-business transaction. Additionally, an electronic payment transaction can involve a plurality of different events including a plurality of database transactions written to a transaction database. In some embodiments, an electronic payment transaction does not involve a card or card account, such as via a direct ACH credit/debit transfer.

In one or more embodiments, the account management system 112 also provides downstream operations based on data associated with electronic payment transactions. Specifically, the account management system 112 utilizes data from electronic payment transactions to provide information (e.g., in one or more reports) about the electronic payment transactions to an owner of an payment account. Additionally, the account management system 112 can utilize the data from electronic payment transactions to provide reporting information to the payment network 114 or to another entity. In some embodiments, the account management system 112 also utilizes downstream operations to provide budgeting services, generate expense reports, or other services based on electronic payment transactions.

In connection with performing additional operations based on data associated with electronic payment transactions, in one or more embodiments, the account management system 112 utilizes the database error correction system 102 to validate functions of the transaction database 108. In particular, the account management system 112 can utilize the database error correction system 102 to perform a plurality of layer checks to validate the current states of the layers based on stored values in the layers according to a set of rules. In additional embodiments, the database error correction system 102 detects errors in the transaction database 108 based on the layer checks in connection with transactions stored in the transaction database 108. Furthermore, the database error correction system 102 can utilize the detected errors to identify causes of the errors in database operators and modify the database operators to correct the errors and/or prevent future errors.

As used herein, the term “database operator” refers to a computer function that performs one or more operations in connections with data in the transaction database 108 or in connection with additional devices communicating with the transaction database 108. In some embodiments, a database operator includes code (e.g., one or more lines, functions, or other portions) in a database management application for storing, accessing, merging, or modifying data in a database. In additional embodiments, a database operator includes code in a communications application (e.g., an application programming interface or “API”) for enabling and executing communications of data between devices or systems.

In one or more additional embodiments, the account management system 112 utilizes the data in the transaction database 108 to perform one or more additional operations. To illustrate, as mentioned, the account management system 112 performs one or more downstream reporting operations based on the data in the transaction database 108 after the database error correction system 102 detects and/or corrects errors in the transaction database 108. For instance, the account management system 112 can perform a downstream reporting operation and provide the results to the payment network 114 and/or to the client device 106. In one or more embodiments, the account management system 112 provides the results for display via the client application 116 of the client device 106. In alternative embodiments, the account management system 112 and/or the database error correction system 102 provide information associated with error detection operations to the client device 106 for display via the client application 116. In additional embodiments, the client device 106 communicates with the account management system 112 in connection with modifying database operators based on detected errors.

In one or more embodiments, in connection with managing payment accounts, the account management system 112 and/or the database error correction system 102 provides one or more additional systems or devices with database management tools and/or account management tools. For example, the one or more additional systems or devices include the client device 106 and/or additional client devices. In one or more embodiments, the account management system 112 provides one or more APIs for the systems or devices to submit a request to perform operations on the data in the transaction database 108. Additionally, the API(s) can provide the client device 106 (or other device associated with a managing entity) with tools to manage databases and/or downstream reporting operations. To illustrate, the client device 106 can communicate with the account management system 112 and/or the database error correction system 102 to issue requests to manage database operations and/or perform downstream reporting operations.

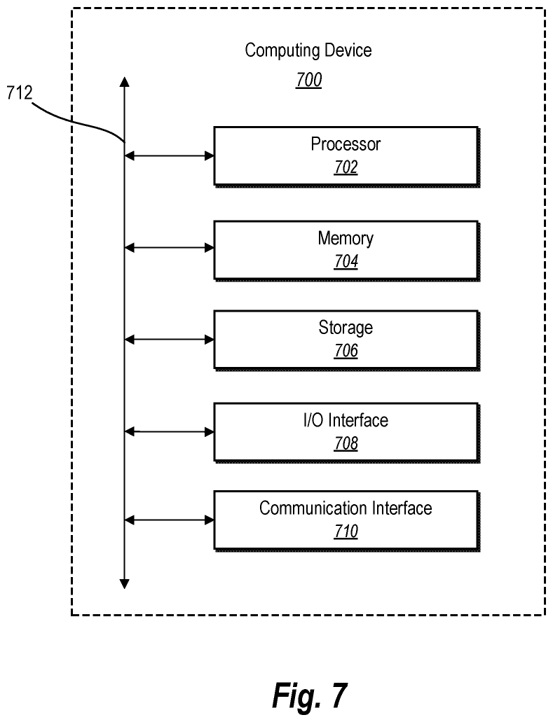

In one or more embodiments, the server(s) 104 include a variety of computing devices, including those described below with reference to FIG. 7. For example, the server(s) 104 includes one or more servers for storing and processing data associated with account management and database management. In some embodiments, the server(s) 104 also include a plurality of computing devices in communication with each other, such as in a distributed storage environment. In some embodiments, the server(s) 104 communicate with a plurality of issuing systems and issuing system devices or other systems and devices of one or more entities based on established relationships between the account management system 112, the database error correction system 102, and the entities. To illustrate, the server(s) 104 communicate with various entities or systems including financial institutions (e.g., issuing banks associated with payment cards via the payment network 114), payment card networks associated with processing payment transactions involving payment cards, payment gateways, merchant systems, client devices, or other systems.

In addition, in one or more embodiments, the account management system 112 and/or the database error correction system 102 are implemented on one or more servers. For example, the account management system 112 and/or the database error correction system 102 can be partially or fully implemented on a plurality of servers. To illustrate, the account management system 112 and the database error correction system 102 can be implemented in a distributed environment. In one or more embodiments, each server handles requests for managing payment accounts and managing databases.

In one or more additional embodiments, the transaction database 108 includes a variety of computing devices, including those described below with reference to FIG. 7. For instance, the transaction database 108 includes one or more servers for storing data associated with payment accounts. In some embodiments, the transaction database 108 includes one or more servers to communicate with the payment network 114 and/or other another system to store data generated in connection with one or more electronic payment transactions. In additional embodiments, the transaction database 108 includes one or more redundant servers for backing up transaction data.

Additionally, as shown in FIG. 1, the system environment 100 includes the network 110. The network 110 enables communication between components of the system environment 100. In one or more embodiments, the network 110 may include the Internet or World Wide Web. Additionally, the network 110 can include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server(s) 104, the account management system 112, the database error correction system 102, the client device 106, and the transaction database 108 communicate via the network 110 using one or more communication platforms and technologies suitable for transporting data and/or communication signals, including any known communication technologies, devices, media, and protocols supportive of data communications, examples of which are described with reference to FIG. 7. Additionally, in one or more embodiments, one or more of the various components of the system environment 100 communicate using protocols for financial information communications such as PCI standards or other protocols.

In addition, as shown in FIG. 1, the system environment 100 includes the client device 106. In one or more embodiments, the client device 106 includes, but is not limited to, a mobile device (e.g., smartphone or tablet), a laptop, a desktop, including those explained below with reference to FIG. 7. Furthermore, although not shown in FIG. 1, the client device 106 can be operated by a user (e.g., a user included in, or associated with, the system environment 100) to perform a variety of functions. In particular, the client device 106 performs functions such as, but not limited to, generating, accessing, viewing, and interacting with data in a database management application. In additional embodiments, the client device 106 performs functions such as, but not limited to, generating, accessing, viewing, and interacting with data in an account management application. For example, the client device 106 communicates with the server(s) 104 via the network 110 to request or provide information associated with a database management program or an account management program. Although FIG. 1 illustrates the system environment 100 with a single client device, in some embodiments, the system environment 100 includes a different number of client devices.

In one or more embodiments, although FIG. 1 is described in relation to electronic payment transactions, the database error correction system 102 can utilize the database management and error correction operations in connection with other types of transactions. In particular, the database error correction system 102 can utilize error detection and correction in connection with any type of transactions in one or more series of related database events. For example, the database error correction system 102 can detect and correct errors for data associated with records storing personal information about user/entity accounts for a service, medical records related to patients or incidents, or other scenarios involving important data for which data consistency/continuity is important.

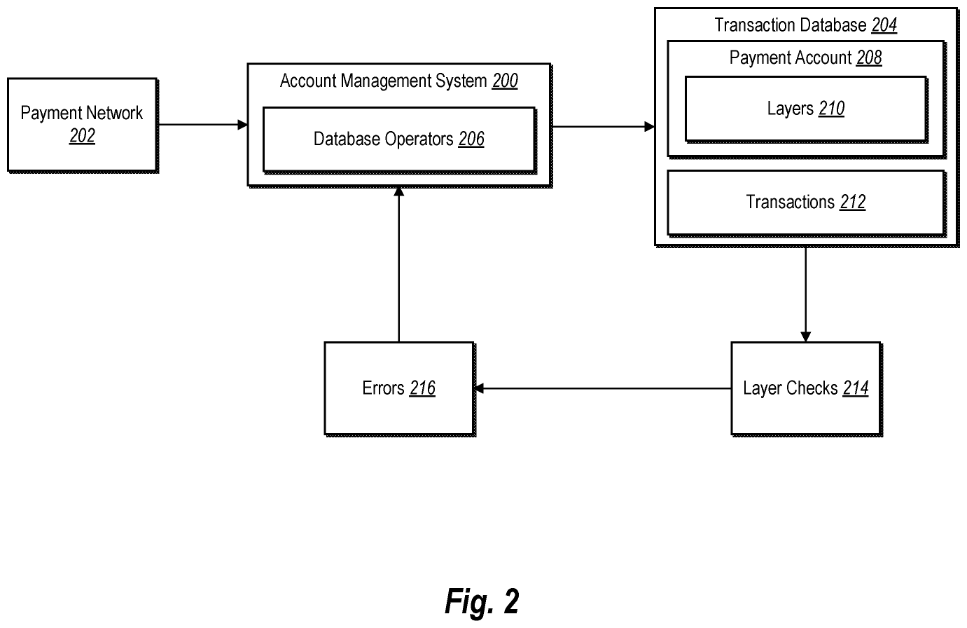

As mentioned, the database error correction system 102 provides database error correction in connection with managing a transaction database for electronic payment transactions. FIG. 2 illustrates an overview of the database error correction system 102 detecting errors in a transaction database. Furthermore, FIG. 2 illustrates the database error correction system 102 correcting the errors in the transaction database by correcting the underlying causes in database operators.

In one or more embodiments, as illustrated in FIG. 2, an account management system 200 is in communication with a payment network 202 for processing data associated with electronic payment transactions. Specifically, the account management system 200 communicates with the payment network 202 to store data associated with specific events in an electronic payment transaction involving a request to transfer funds from a payment account to a recipient account. For example, the account management system 200 communicates with one or more systems in the payment network 202 (e.g., a payment gateway system, a card network, or an issuing bank system) and/or one or more additional entities (e.g., a merchant system) to send and receive data associated with an electronic payment transaction between a funding user and a recipient user.

According to one or more embodiments, in connection with processing an electronic payment transaction, the account management system 200 communicates with a transaction database 204 to store data associated with the electronic payment transaction. For instance, the account management system 200 includes database operators 206 to communicate with the payment network 202 to determine information associated with an electronic payment transaction. Additionally, the account management system 200 includes the database operators 206 to store the information associated with an electronic payment transaction in the transaction database 204. To illustrate, as mentioned previously, the database operators 206 include code in one or more computer applications to generate or modify data for storing in the transaction database 204 based on events associated with an electronic payment transaction.

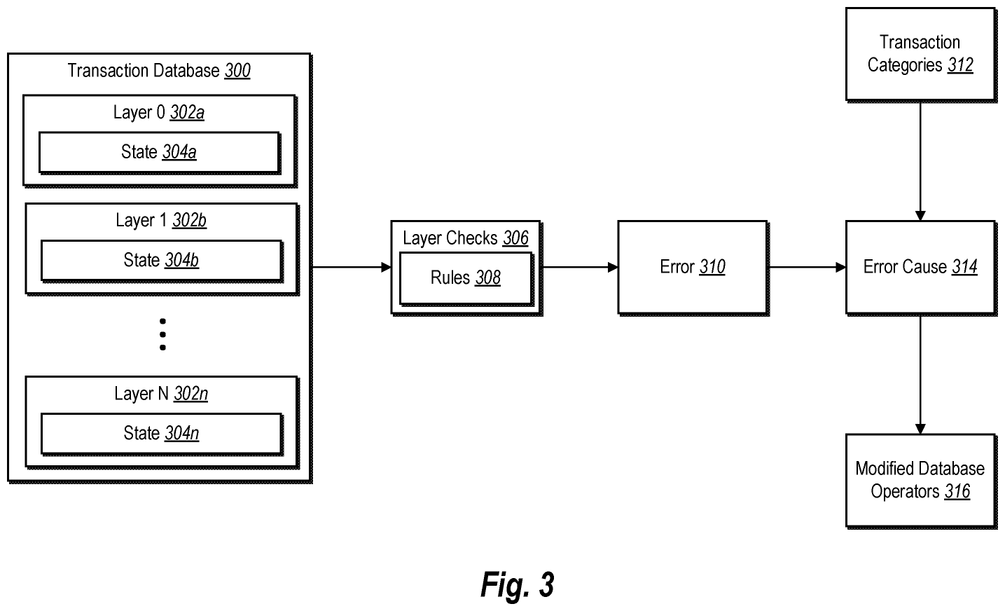

In one or more embodiments, the transaction database 204 includes data associated with an payment account 208 in connection with electronic payment transactions. As mentioned, a payment account 208 includes a plurality of layers 210 representing different fund values associated with the payment account 208. Each layer of the payment account 208 includes a separate balance including a state of the corresponding fund value based on a plurality of transactions 212 stored in the transaction database 204. For instance, as mentioned, the layers 210 can include balances corresponding to funds not yet available, funds authorized but not settled, funds available for spending, amount of overdraft, rewards values, pending credits, Just-In-Time pending loans (e.g., authorized but temporarily held funds), ACH origination, etc. FIG. 3 and the corresponding description provides additional detail associated with a transaction database.

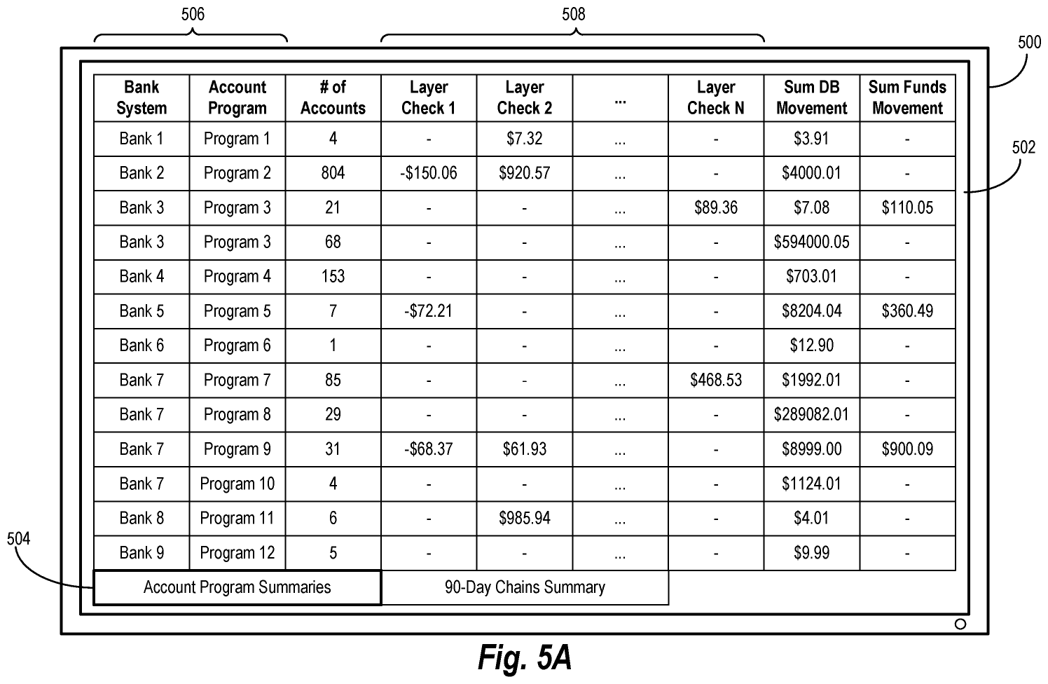

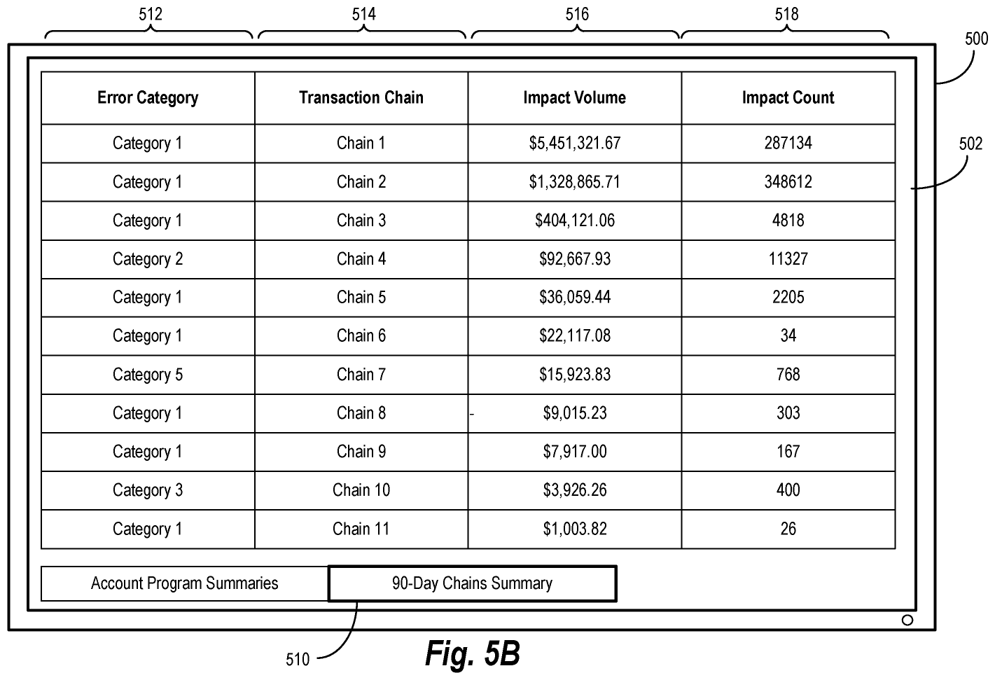

Additionally, FIG. 2 illustrates that the database error correction system 102 performs layer checks 214 on the layers 210 to detect errors 216 in the transaction database 204. In particular, the database error correction system 102 determines whether the information stored for the layers 210 in the transaction database 204 based on the transactions 212 result in one or more errors. Furthermore, FIG. 2 illustrates that the database error correction system 102 utilizes the errors 216 to modify the database operators 206 of the account management system 200. FIGS. 3 and 5A-5B and the corresponding description provide additional detail with respect to detecting and correcting errors in a transaction database.

FIG. 3 illustrates additional detail associated with the database error correction system 102 detecting and correcting errors in a transaction database. Specifically, FIG. 3 illustrates that a transaction database 300 includes a plurality of separate layers 302a-302n representing different types of funds associated with one or more payment accounts. As described below, the different types of funds can have different purposes and/or represent values at different stages of a given electronic payment transaction.

Additionally, in one or more embodiments, the database error correction system 102 labels each of the layers 302a-302n according to the type of funds and/or currency. For instance, the database error correction system 102 labels each layer with a plurality of digits including a layer number (e.g., 0-6) followed by a number representing a specific currency (e.g., a currency code). To illustrate, the database error correction system 102 uses a first currency code for US dollars, a second currency code for Canadian dollars, etc. Accordingly, the layer label can include the layer number followed by a plurality of digits representing the currency code of the payment account or layer—e.g., 0840 to represent a first layer storing funds in US dollars.

For example, the first layer represents a cash layer that includes funds available to spend instantly. When the database error correction system 102 determines that funds clear for an electronic payment transaction involving the payment account, the database error correction system 102 moves funds out of the payment account entirely and deducts the value from a ledger balance corresponding to the payment account. Accordingly, in some embodiments, the cash layer may not take into account funds that will become available at a later date.

In one or more embodiments, a second layer represents funds authorized but not yet cleared for the payment account. Additionally, a third layer can represent an amount of overdraft on the payment account, which is essentially equivalent to providing credit to the payment account (e.g., by an account management system), resulting in funds owed by the account to the entity that provided credit. In addition, a fourth layer can represent merchant/card rewards, which include liabilities that a managing system needs to collect (e.g., funds not yet obtained and stored at the bank, such as in connection with offers or orders that have a reward amount).

In one or more embodiments, a fifth layer represents credits pending to the payment account that may be moved to the first layer or released depending on subsequent actions. For instance, the fifth layer can represent funds used for pending chargeback credits or for ACH loads that have been accepted but for which a funding time has not yet elapsed. Accordingly, the fifth layer can be tied to one or more additional layers depending on electronic payment transactions in processing.

According to additional embodiments, a sixth layer represents Just-In-Time (“JIT”) pending loads. In particular, for JIT programs, such loads represent authorized funds that are temporarily held for transactions that involve clearing electronic payment transactions prior to receiving funds from a funding source (e.g., for faster transaction clearance). Thus, the balance for the sixth layer is related to the balance of the second layer for JIT programs. Additionally, in some embodiments, the sixth layer is considered part of a ledger balance (e.g., for the payment account) while the second layer 302b is not. Accordingly, the sixth layer allows for the use of the ledger balance to view the volume of funds currently in transit for a JIT account holder. In one or more embodiments,

In some embodiments, a seventh layer impacts the available balance for the payment account without impacting the ledger balance. To illustrate, the seventh layer has two use cases involving ACH origination and credit. For example, ACH origination leverages the seventh layer for a user use case (e.g., a transfer originated from a cardholder account) and a program use case (e.g., transfers originated from program funding reserve accounts). The account management system deducts funds from the seventh layer to prevent double spending of funds until a corresponding transaction settles and hits the first layer—thus, the seventh layer can be similar to the second layer in such a use case by temporarily holding funds while the transfer is pending (e.g., not settled). In the second use case, a system can use the seventh layer to manage credit lines, thereby increasing or decreasing the available funds for the account without impacting the ledger balance, which helps the account management system prevent indications of cash movement that has not actually occurred in the transaction database 300.

In additional embodiments, a payment account has more or fewer layers than those described above. For example, the payment account can include one or more merchant-specific layers associated with one or more merchant systems. Additionally, a payment account can include only three layers (e.g., the first layer, the second layer, and the fifth layer described above).

In one or more embodiments, the layers 302a-302n have corresponding states 304a-304n based on the fund values in the layers 302a-302n. For instance, the database error correction system 102 determines the states 304a-304n based on transactions in the transaction database 300. To illustrate, as an account management system receives data for processing electronic payment transactions, the account management system stores the information in respective layers of the transaction database according to the type of information received. More specifically, the account management system can modify a balance of a given layer based on whether the type of transaction is an authorization, a settlement, or any other part of an electronic payment transaction that results in modifying or generating transaction entries within one or more layers of the transaction database 300.

According to one or more embodiments, as illustrated in FIG. 3, the database error correction system 102 uses layer checks 306 to determine whether the transaction database 300 contains any errors. Specifically, the database error correction system 102 performs the layer checks 306 according to rules 308 that based on the states 304a-304n of the layers 302a-302n. For example, the database error correction system 103 performs the layer checks 306 based on requirements that specific layers have values that meet one or more threshold values or based on comparing the states of two or more layers. To illustrate, the rules 308 can include rules based on comparing the states of two or more layers to each other. Additionally, the rules 308 can include rules based on comparing the state of a single layer to a given threshold value (e.g., determining whether a state of a layer indicates a positive or a negative fund value). The database error correction system 102 thus uses the layer checks 306 to determine whether the states of the layers are correct according to intended values based on electronic payment transactions that the account management system has processed.

In one or more embodiments, in response to determining that the layers 302a-302n do not pass the layer checks 306 (e.g., one or more layer checks on one or more layers or groups of layers fails), the database error correction system 102 detects an error 310. For instance, the database error correction system 102 determines that one or more of the states 304a-304n indicates an incorrect fund value in one or more of the layers 302a-302n. To illustrate, the error 310 can be a result of one or more transactions in the transaction database 300 incorrectly the fund values corresponding to one or more layers. As an example, one or more transactions in the transaction database 300 can result in a state of a given layer being positive when the state should be negative, or vice versa. Accordingly, the database error correction system 102 detects the error 310 based on the layer checks 306 and the rules 308.

In one or more embodiments, the database error correction system 102 determines a cause of the error 310. For example, the database error correction system 102 determines that specific types of transactions or groups of related transactions tend to cause specific types of errors. Accordingly, as illustrated in FIG. 3, the database error correction system 102 utilizes transaction categories 312 of transactions in the transaction database 300 to determine an error cause 314 associated with one or more systems, devices, or applications that operate on or with the transaction database 300.

More specifically, the database error correction system 102 determines correlations between the transaction categories 312 and specific error types. The database error correction system 102 can also determine likelihoods/probabilities of possible error causes based on the correlations. To illustrate, certain types of transactions correlating to certain types of errors can be indicative of certain causes in one or more systems, devices, or applications. Accordingly, the database error correction system 102 determines the error cause 314 by identifying a correlation between the error 310 and one or more related transaction categories and selecting the error cause 314 from one or more likely causes associated with the correlated transaction categories and error 310.

In one or more embodiments, as illustrated in FIG. 3, in response to determining the error cause 314, the database error correction system 102 determines modified database operators 316 to correct the error cause 314. For example, the database error correction system 102 determines one or more portions of code in a database management application, API, or other communications application that communicates with the transaction database 300 to access, store, delete, or otherwise modify data (e.g., transactions) at the transaction database 300. To illustrate, error causes can include functions or other sections of code that, when executed, incorrectly interact with the transaction database 300 to store or modify data via database transactions, such as by performing an unexpected/erroneous operation on data at a given time or not performing a specific operation on data at a particular time. Thus, by modifying one or more database operators in one or more systems, devices, or applications, the database error correction system 102 can correct the error 310 and/or prevent similar errors from occurring in the future.

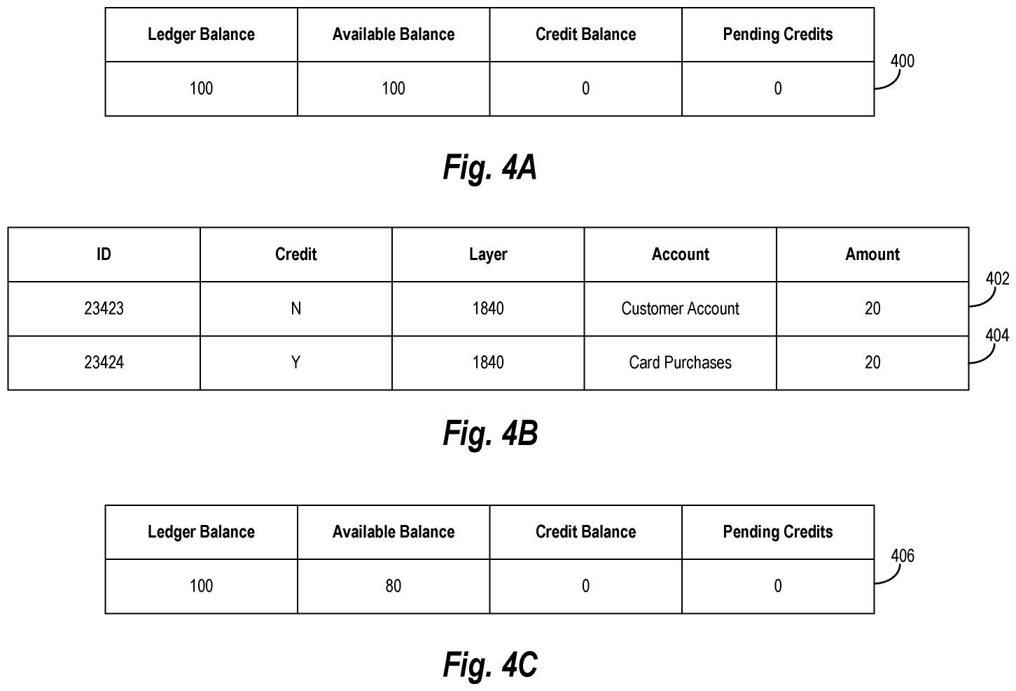

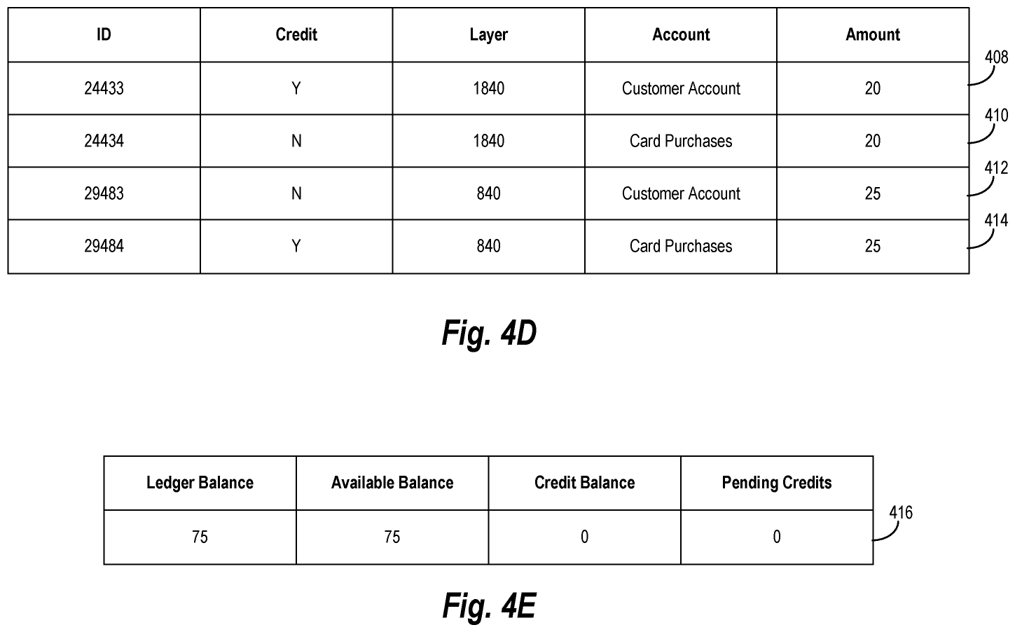

FIGS. 4A-4E illustrate information associated with layer states for a payment account and a plurality of transactions associated with an electronic payment transaction involving the payment account. Specifically, as previously mentioned, an electronic payment transaction can be associated with a plurality of database transactions at a transaction database. For instance, an electronic payment transaction can include a plurality of operations including authorization of a transfer of funds, modification of a fund value associated with the transfer of funds, finalizing the transfer of funds, chargeback of at least a portion of transferred funds, rewards associated with the transfer of funds, etc. Accordingly, the electronic payment transaction can involve an account management system (or other system) writing a plurality of database transactions to the transaction database during processing of the electronic payment transaction.

In one or more embodiments, a transaction database associated with a payment account includes a record of all electronic payment transactions and events associated with each electronic payment transaction. Accordingly, the transaction database includes indications of each time funds moved, sources and destinations of fund transfers, and quantities of funds that moved. In particular, the transaction database stores raw data including all credits and debits that occur in connection with the payment account and accumulate over time. For example, the transaction database captures four critical types of data: 1) credits and debits, 2) payment account identifier, 3) fund values/transfer values, and 4) layer identifiers. In one or more embodiments, each credit to a layer or account should be offset by a debit of equal amount such that the movement of funds balances out across all layers. Subsequently, each electronic payment transaction involves at least two rows (or entries) in the transaction database—one for a credit event and one for a debit event.

FIG. 4A illustrates a balance table including fund information (e.g., line items) associated with a payment account. In particular, FIG. 4A illustrates a row 400 of the balance table including a plurality of balances associated with the payment account. In one or more embodiments, the row 400 includes a plurality of balances provided in connection with an API request inquiring about one or more balances for a payment account. To illustrate, the balances include a ledger balance (e.g., a balance of the payment account based on finalized electronic payment transactions), an available balance (e.g., a balance of funds currently available for electronic payment transactions based on finalized fund transfers and temporary holds on the payment account associated with transactions still being processed), a credit balance, and a pending credits balance. As illustrated in FIG. 4A, the row 400 indicates that the ledger balance and the available balance for the payment account include a $100 initial balance.

As indicated previously, one or more layers of the payment account can impact one or more of the balances associated with the payment account. To illustrate, one or more layers of the payment account impact the available balance without impacting the ledger balance. Additionally, one or more layers of the payment account impact the available balance and the ledger balance. Similarly, one or more layers of the payment account may impact the credit balance and/or the pending credits balance without impacting the ledger balance or the available balance.

FIG. 4B illustrates a plurality of transactions in a transaction database in connection with the payment account. For example, in connection with a dual message electronic payment transaction associated with a card-swipe or payment event for a particular amount, an account management system performs an authorization action to authorize a transfer of funds from the payment account for a transaction amount (e.g., by validating an account number, whether the account is active, whether the balance is sufficient, whether the transaction passes fraud checks). The account management system debits funds from a first layer (e.g., a layer indicating funds that have been authorized but not cleared) to place a temporary hold on funds equal to the transaction amount (in this case, $20) and provides a notification of the hold with authorization. In connection with the authorization action, the transaction database stores two rows (a first row 402 and a second row 404) including information about a funding account and a destination account, the corresponding layer(s), and the transaction amount.

FIG. 4C illustrates a row 406 of the balance table corresponding to the payment account including updated balances associated with the payment account in response to the temporary hold on funds. Specifically, by placing a temporary hold on funds equal to the transaction amount, the account management system updates the available balance by the transaction amount without modifying the ledger balance. Thus, the account management system deduct the $20 from the available balance, resulting in an available balance of $80. Furthermore, the ledger balance still has a value of $100 due to the funds not yet clearing.

In one or more embodiments, as part of the electronic payment transaction, an account holder modifies the electronic payment transaction to include a tip, thereby changing the total transaction amount for clearing. Accordingly, the account management system updates the transaction database to perform one or more additional operations in connection with modifying the transaction amount. In particular, as illustrated in FIG. 4D, the transaction database includes a plurality of additional rows reversing the temporary hold for the previously indicated transaction amount ($20) and placing a temporary hold for the updated transaction amount ($25). For example, the account management system writes a first row 408 and a second row 410 to the transaction database to reverse the first temporary hold for the initial transaction amount and a third row 412 and a fourth row 414 to the transaction database to place the temporary hold for the updated transaction amount.

FIG. 4E illustrates a row 416 of the balance table including final balances ($75) associated with the payment account after the account management system releases the temporary hold on the funds and clears the electronic payment transaction for the final amount (e.g., the initial transaction amount in combination with the tip amount) at a later time. As illustrated, after the account management system clears the funds for the electronic payment transaction according to the updated transaction amount, the account management system updates the ledger balance to reflect the deduction of the updated transaction amount. Additionally, the account management system updates the available balance to reflect the deduction of the final transaction amount.

For a given electronic payment transaction, correctly processing the electronic payment transaction results in the flow illustrated in FIGS. 4A-4E. Accordingly, the database error correction system 102 may not detect any errors in the transaction database as a result of the correctly processed electronic payment transaction. In one or more additional embodiments, incorrectly processing an electronic payment transaction results in one or more layers having values that incorrectly impact one of the balances in the balance table. To illustrate, in response to one or more operators incorrectly placing a temporary hold on funds, incorrectly releasing funds, incorrectly selecting a layer (e.g., with an incorrect layer identifier), etc., the database error correction system 102 detects one or more errors via a plurality of layer checks on the layers associated with the payment account in the transaction database.

In one or more embodiments, as previously mentioned, in connection with processing electronic payment transactions, an account management system (e.g., the account management system 112 of FIG. 1 or the account management system 200 of FIG. 2) stores data in a transaction database. For instance, the account management system generates one or more rows in the transaction database in connection with each operation (e.g., authorization, clearing, chargeback) performed during processing an electronic payment transaction.

In connection with processing electronic payment transactions, or otherwise in connection with validating data in the transaction database, the database error correction system 102 detects errors in the transaction database. Additionally, in one or more embodiments, the database error correction system 102 generates interactive reports for display within a graphical user interface. For example, FIGS. 5A-5B illustrate graphical user interfaces including interactive reports for displaying results of layer checks on a plurality of layers associated with a payment account and prioritized data indicating causes of detected errors.

FIG. 5A illustrates a graphical user interface for displaying an interactive report in connection with performing layer checks on a plurality of layers associated with a payment account. Specifically, FIG. 5A illustrates a client device 500 (e.g., a desktop device, a laptop device, or a mobile device) for displaying the graphical user interface within a client application 502. In one or more embodiments, the client application 502 includes a database management application for managing data in a transaction database. For example, the client device 500 displays tools for analyzing data in the transaction database to detect errors and correct detected errors in a database management system.

In one or more embodiments, the client device 500 displays, within the client application 502, a spreadsheet interface for displaying a first interactive report in a first tab 504. Specifically, the first interactive report includes a summary of analyzed data associated with one or more card/account programs and/or one or more payment accounts. For example, FIG. 5A illustrates that the first interactive report includes a first set of columns 506 indicating card/account programs associated with specific bank systems. To illustrate, each card/account program is associated with a bank system (e.g., an issuing bank system that issues cards/accounts in accordance with the card/account program). In some instances, a single bank system may be associated with a plurality of different card/account programs (e.g., as illustrated in FIG. 5A, such as for “Bank 7”). The client device 500 may also indicate a number of payment accounts associated with a particular combination of a bank system and card/account program.

In additional embodiments, as illustrated in FIG. 5A, the client device 500 displays that the first interactive report includes results 508 of layer checks in connection with payment accounts. In particular, the database error correction system 102 performs a plurality of layer checks according to a set of rules to detect errors in layers of the payment accounts. For instance, the database error correction system 102 performs one or more layer checks on one or more layers to determine whether the corresponding states indicate that the layer states are positive or negative. To illustrate, in response to determining that a given layer has a positive state, the database error correction system 102 can determine that the layer indicates an error based on a first rule.

As an example, the database error correction system 102 can determine that a layer corresponding to funds authorized but not yet cleared should always be negative. In response to determining that the layer has a positive state, the database error correction system 102 can detect an error that resulted in the layer having the positive state. Accordingly, the client device 500 can display an indicator in a column and row corresponding to the layer check and combination of card/account program and bank system. For example, the client device 500 displays a fund value corresponding to the layer that indicates the positive state that resulted in failing the layer check.

In another example, the database error correction system 102 can compare the states of two different layers with fund values that should correspond to each other based on transactions in the transaction database. Specifically, in some embodiments, the database error correction system 102 determines rules that require a first state of a first layer to be exactly opposite a second state of a second layer. For instance, the database error correction system 102 determines whether a current value stored for a layer corresponding to funds authorized but not yet cleared is exactly opposite a current value stored for a layer corresponding to JIT pending loads (e.g., −5.00 and +5.00). In response to determining that the first layer and the second layer have states that are not exactly opposite, the database error correction system 102 determines that the layers fail the layer check, resulting in an error.

Additionally, in some embodiments, the database error correction system 102 performs sets of layer checks in connection with different groups of transactions in the transaction database. In particular, the database error correction system 102 can perform a set of layer checks on layers based on the most recent transactions (e.g., transactions within a predetermined amount of time period such as the last 30 days). Additionally, the database error correction system 102 can perform a set of layer checks (e.g., the same layer checks or different layer checks) on the layers based on additional transactions for a different time period (e.g., transactions between 30 days and 90 days before a current time). Thus, the database error correction system 102 can determine whether an error began to occur recently, whether an error is ongoing over an extended period of time, or whether an error stopped occurring at some time in the past.

In additional embodiments, the client device 500 displays additional detail associated with the layer checks and/or transactions for specific card/account programs or bank systems. For example, FIG. 5A illustrates that the first interactive report includes information indicating a sum of funds movement within the database (e.g., funds transfers among layers of each payment account) and a sum of funds movement (e.g., funds transfers from payment accounts to recipient accounts). Such information can provide additional insight for determining whether errors have occurred in database operators.

As previously mentioned, in one or more embodiments, the database error correction system 102 detects an error the layers of one or more payment accounts in response to determining that one or more layers fail the layer checks. Accordingly, the first interactive report indicates whether a given card/account program has any errors in response to determining that one or more layer checks fail for one or more layers. For example, the client device 500 displays a plurality of options for sorting the card/account programs based on a given layer check. To illustrate, in response to a selection to sort the card/account programs based on a value in a column of the results 508 of the layer checks, the client device 500 can modify the order of the rows to place card/account programs that have one or more errors in the selected column at the top of the first interactive report. The client device 500 can similarly sort the first interactive report for other columns corresponding to specific layer checks for easy identification of card/account programs corresponding to errors.

FIG. 5B illustrates the client device 500 displaying a graphical user interface of the client application 502 including a second interactive report (e.g., via a second tab 510 of the spreadsheet interface) associated with detecting errors in a transaction database. Specifically, as mentioned, the database error correction system 102 determines correlations between specific types of errors and groups of related transactions. Accordingly, FIG. 5B illustrates that the second interactive report includes data associated with the identified correlations.

In one or more embodiments, the client device 500 displays, within the second interactive report, a first column 512 including one or more identified error categories. For example, the database error correction system 102 determines the error categories corresponding to errors detected in the transaction database based on the layer checks. To illustrate, each layer check can correspond to a different error category indicative of a specific error corresponding to one or more layers of one or more payment accounts.

Additionally, the client device 500 displays a second column 514 including groups of related transaction chains. Specifically, the database error correction system 102 can determine a group of related transaction chains from the transaction database based on database events that occur for specific electronic payment transactions involving a payment account. For instance, a particular transaction chain can include one or more authorization operations, one or more credit operations, one or more clearing operations, etc. In additional embodiments, the database error correction system 102 determines groups of related transactions based on characteristics of the transactions (e.g., based on the similarity of the transactions or which layers the transactions touch). Each identified transaction chain includes a unique set of related transaction categories that combine to achieve one or more overall operation (e.g., a specific electronic payment transaction) associated with a payment account.

As further illustrated in FIG. 5B, the database error correction system 102 determines correlations between the error categories and the groups of related transaction chains in response to detecting errors in connection with specific transaction chains. According to one or more embodiments, the database error correction system 102 determines the correlations based on a likelihood or probability of an error occurring given a set of related transactions (e.g., based on a number of transactions corresponding to specific error categories. Furthermore, the database error correction system 102 can also determine that any given error category correlates to a plurality of different transaction chains (e.g., indicating that one or more layers are impacted incorrectly in the same way by a variety of different transaction chains).

In one or more embodiments, the database error correction system 102 indicates the correlations via primary keys that map the error categories to the transaction chains. For example, the database error correction system 102 utilizes each primary key to quantify the impact of a particular combination of error category and transaction chain. In some embodiments, the primary key also allows for efficient determination of likely causes of a particular combination of error category and transaction chain.

According to one or more embodiments, the client device 500 also displays a third column 516 indicating an impact volume resulting from a particular error category and transaction chain. The client device 500 can also display a fourth column 518 indicating an impact count (e.g., a number of times a particular transaction chain resulted in a particular error category). Thus, the database error correction system 102 can determine that specific error categories result from specific transaction chains in a plurality of instances. Additionally, certain types of error categories correlated with specific transaction chains can result in a greater impact on the transaction database than other error category/transaction chain combinations.

In one or more embodiments, the database error correction system 102 modifies the second interactive report based on a ranking or priority assigned to combinations of error categories and transaction chains. To illustrate, the database error correction system 102 can assign a priority based on the impact volume and/or impact count associated with each combination. For example, the database error correction system 102 can rank the combinations based solely on the impact volume. In additional embodiments, the database error correction system 102 ranks the combinations based on a combination of the impact volume and the impact count (e.g., by assigning a weight to each value and then combining the weighted values into an impact score). By prioritizing the combinations with the greatest impact, the database error correction system 102 can correct the most impactful errors first (e.g., before less impactful errors).

In one or more embodiments, the client device 500 also provides additional information associated with detected errors, corresponding transaction chains, or other details associated with database operators in connection with a transaction database. Specifically, the database error correction system 102 can provide tools for selecting a specific group of related transaction categories within the client application 502 via the second interactive report. For example, in response to a selected transaction chain or error category, the database error correction system 102 can provide, for display at the client device 500, an additional report including detailed information associated with the transaction chain or error category. To illustrate, the client device 500 can display layers impacted by a specific transaction chain, including layer states for card/account programs affected by transactions in the transaction chain.

By displaying additional details associated with a given transaction chain, the database error correction system 102 allows for more accurate and efficient identification of potential causes of errors in connection with the transaction chain. For instance, evaluating the details of the transaction chain can lead to an indication of a cause related to one or more database operators. As an example, an error corresponding to a particular transaction chain can indicate that a database operator for migrating data from a first database or device to a second database or device stopped functioning at some point in the past. Accordingly, identifying the cause via the interactive reports can allow the database error correction system 102 to rectify the error by fixing the underlying cause in the database operator. To illustrate, the database error correction system 102 modifies code (e.g., fixing code that incorrectly fails to expire certain transactions in a timely manner) or executing one or more existing lines of code that stopped running on the transaction database or on a related system.

In one or more embodiments, the database error correction system 102 automatically modifies one or more database operators in response to detecting an error and identifying a corresponding cause. For instance, the database error correction system 102 can generate probabilities of a plurality of possible causes of an error in connection with determining correlations between error categories and transaction chains. The database error correction system 102 can select a specific cause, and in response to determining that automatic correction of the error is possible, the database error correction system 102 can automatically correct the cause of the error by modifying a corresponding database operator or executing the corresponding database operator. In some instances, modifying the database operator involves rolling back previous changes made to the database operator that led to errors in the transaction database.

In additional embodiments, the database error correction system 102 modifies a database operator by generating recommended actions for correcting a cause of one or more errors. To illustrate, in response to determining the likelihood of one or more possible causes of an error, the database error correction system 102 can generate a recommended action to modifying a database operator associated with the cause. In some embodiments, the database error correction system 102 also locates the database operator and provides the database operator (e.g., via a link) for display with the recommended action within the client device 500. In further embodiments, the database error correction system 102 determines that the database operator requires modification to correct one or more errors and provides instructions to a database administrator to modify the database operator.

In some embodiments, the database error correction system 102 also performs automatic testing of modified database operators. In particular, in response to modifying a database operator in connection with a detected error in a transaction database, the database error correction system 102 can utilize the database operator to process transactions associated with the error. To illustrate, the database error correction system 102 can execute the database operator and determine whether the modified database operator corrected the error by re-executing one or more layer checks on the updated layers of the payment account in the transaction database. In response to determining that the modified database operators did not fix the error or introduced additional errors, the database error correction system 102 can revert the changes to the database operator and identify the next most likely cause of the error. The database error correction system 102 can continue attempting to correct the error by modifying one or more database operators according to the probabilities assigned to various causes.

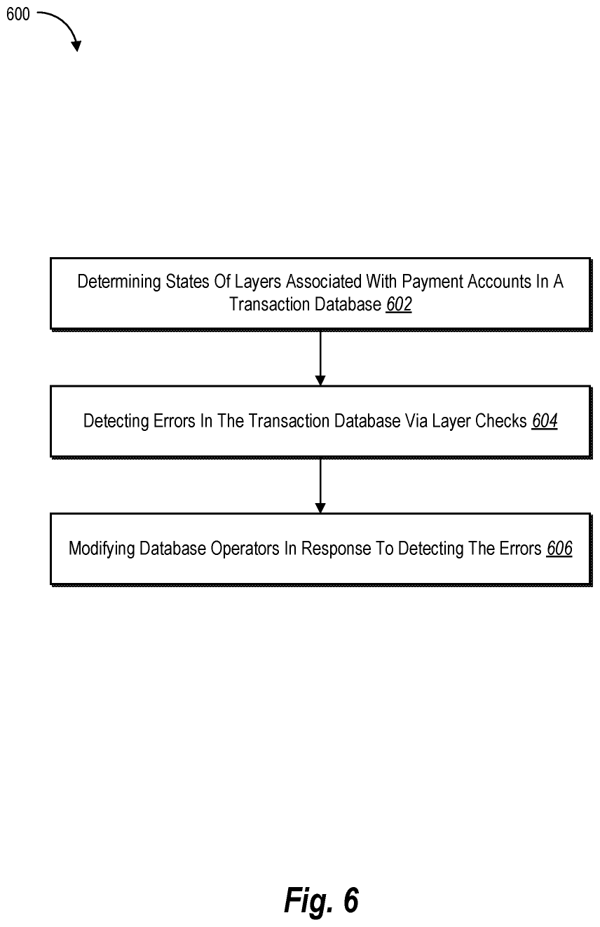

Turning now to FIG. 6, this figure shows a flowchart of a series of acts 600 of detecting errors in database transactions and modifying database operators. While FIG. 6 illustrates acts according to one embodiment, alternative embodiments may omit, add to, reorder, and/or modify any of the acts shown in FIG. 6. The acts of FIG. 6 can be performed as part of a method. Alternatively, a non-transitory computer readable storage medium can comprise instructions, that when executed by one or more processors, cause a computing device to perform the acts of FIG. 6. In still further embodiments, a system can perform the acts of FIG. 6.

As shown in FIG. 6, the series of acts 600 includes an act 602 of determining states of layers associated with payment accounts in a transaction database. For example, act 602 involves determining, based on a plurality of transactions in a transaction database corresponding to one or more payment accounts, states of a plurality of layers representing fund values associated with the one or more payment accounts.

Act 602 can involve determining one or more transactions corresponding to a layer of the plurality of layers. Act 602 can also involve determining a state of the layer based on a fund value resulting from the one or more transactions.

The series of acts 600 also includes an act 604 of detecting errors in the transaction database via layer checks. For example, act 604 involves detecting one or more errors in the transaction database via layer checks on the plurality of layers according to rules associated with the plurality of layers and the states of the plurality of layers.

Act 604 can involve generating the rules associated with the plurality of layers. For example, act 604 can involve generating one or more layer relationship rules comprising comparisons of fund values of the plurality of layers. Act 604 can also involve generating one or more layer value rules comprising comparisons of individual fund values of the plurality of layers to one or more threshold values.

Act 604 can involve determining a layer relationship rule comprising a requirement that a first fund value of a first layer of the plurality of layers has a particular relationship with a second fund value of a second layer of the plurality of layers. Act 604 can also involve detecting an error in the transaction database in response to determining that the first fund value does not have the particular relationship with the second fund value. To illustrate, act 604 can involve determining that a first fund value is not exactly opposite the second fund value.

Act 604 can also involve determining one or more transactions of the plurality of transactions that result in the layer checks failing for the plurality of layers. Act 604 can involve determining one or more error categories of the one or more errors based on the one or more transactions.

Act 604 can involve performing the layer checks on a layer of the plurality of layers based on: a first rule comparing a fund value of the layer to a threshold value; and a second rule comparing the fund value of the layer to one or more additional fund values of one or more additional layers of the plurality of layers. Act 604 can also involve detecting an error in response to the layer of the plurality of layers failing the layer checks based on the first rule or the second rule. For example, act 604 can involve detecting, based on the layer checks on the plurality of layers according to the rules, an error in a layer in response to determining that the fund value of the layer is incorrect.

In one or more embodiments, the series of acts 600 includes determining correlations between groups of related transaction categories and error categories. For example, the series of acts 600 include determining a transaction chain comprising a set of related transactions including the one or more transactions that result in the layer checks failing for the plurality of layers. For example, the series of acts 600 can include determining a transaction chain comprising a plurality of transactions resulting in the incorrect fund value of the layer. The series of acts 600 can include generating, for display on a client device, an indication of an error of the one or more error categories corresponding to the transaction chain. The series of acts 600 can include determining the correlations between the groups of related transaction categories and the error categories based on a transaction history of the plurality of transactions in the transaction database and an error history associated with the plurality of transactions in the transaction database.

For example, the series of acts 600 can include determining a plurality of correlations between groups of related transaction categories and the one or more error categories. The series of acts 600 can include determining a cause of the error in the one or more database operators based on the plurality of correlations. The series of acts 600 can include determining the cause of the one or more errors based on the correlations and a transaction chain comprising a set of transactions associated with the one or more errors in the transaction database. The series of acts 600 can include determining a cause of the error based on a correlation between a group of transaction categories of transactions in the transaction chain and an error category of the error.

Additionally, the series of acts 600 can include determining, based on the error, a value impact on the fund values of the plurality of layers or one or more balances of the one or more payment accounts. The series of acts 600 can include generating, for display on the client device, a prioritized list of errors comprising the error according to the value impact on the fund values or the one or more balances.

Additionally, the series of acts 600 includes an act 606 of modifying database operators in response to detecting the errors. For example, act 606 involves modifying, in response to detecting to the one or more errors in the transaction database, one or more database operators associated with the transaction database.

Act 606 can involve modifying database application code comprising one or more database storage operators or application programming interface operators in connection with receiving and storing transaction data associated with usage of the one or more payment accounts.

Act 606 can involve determining a cause of the one or more errors resulting from a database storage operator or an application programming interface operator in connection with receiving and storing transaction data associated with usage of the one or more payment accounts. Act 606 can also involve modifying the database storage operator or the application programming interface operator in connection with processing transactions for the one or more payment accounts.

Act 606 can involve determining, based on the plurality of transactions and the states of the plurality of layers, that a database management application comprises code resulting in the one or more errors. Act 606 can also involve modifying the code of the database management application to correct the one or more errors.

The series of acts 600 can include generating, for display at a client device, a first interactive report comprising indications of the one or more errors based on one or more states of one or more layers of the one or more payment accounts that fail the layer checks. The series of acts 600 can include generating, for display at the client device, a second interactive report comprising a summary of transaction chains that correlate to one or more error categories within a previous time period.

The series of acts 600 can include determining, based on instances of transactions in the transaction database corresponding to groups of related transaction categories, value impacts of the one or more errors on the fund values of the plurality of layers or one or more balances of the one or more payment accounts. The series of acts 600 can also include generating, for display with the second interactive report at the client device, a prioritized list of errors comprising the one or more errors according to the value impacts of the one or more errors.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 7 illustrates a block diagram of exemplary computing device 700 that may be configured to perform one or more of the processes described above. One will appreciate that one or more computing devices such as the computing device 700 may implement the system(s) of FIG. 1. As shown by FIG. 7, the computing device 700 can comprise a processor 702, a memory 704, a storage device 706, an I/O interface 708, and a communication interface 710, which may be communicatively coupled by way of a communication infrastructure 712. In certain embodiments, the computing device 700 can include fewer or more components than those shown in FIG. 7. Components of the computing device 700 shown in FIG. 7 will now be described in additional detail.

In one or more embodiments, the processor 702 includes hardware for executing instructions, such as those making up a computer program. As an example, and not by way of limitation, to execute instructions for dynamically modifying workflows, the processor 702 may retrieve (or fetch) the instructions from an internal register, an internal cache, the memory 704, or the storage device 706 and decode and execute them. The memory 704 may be a volatile or non-volatile memory used for storing data, metadata, and programs for execution by the processor(s). The storage device 706 includes storage, such as a hard disk, flash disk drive, or other digital storage device, for storing data or instructions for performing the methods described herein.

The I/O interface 708 allows a user to provide input to, receive output from, and otherwise transfer data to and receive data from computing device 700. The I/O interface 708 may include a mouse, a keypad or a keyboard, a touch screen, a camera, an optical scanner, network interface, modem, other known I/O devices or a combination of such I/O interfaces. The I/O interface 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 708 is configured to provide graphical data to a display for presentation to a user. The graphical data may be representative of one or more graphical user interfaces and/or any other graphical content as may serve a particular implementation.

The communication interface 710 can include hardware, software, or both. In any event, the communication interface 710 can provide one or more interfaces for communication (such as, for example, packet-based communication) between the computing device 700 and one or more other computing devices or networks. As an example, and not by way of limitation, the communication interface 710 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 710 may facilitate communications with various types of wired or wireless networks. The communication interface 710 may also facilitate communications using various communication protocols. The communication infrastructure 712 may also include hardware, software, or both that couples components of the computing device 700 to each other. For example, the communication interface 710 may use one or more networks and/or protocols to enable a plurality of computing devices connected by a particular infrastructure to communicate with each other to perform one or more aspects of the processes described herein. To illustrate, the digital content campaign management process can allow a plurality of devices (e.g., a client device and server devices) to exchange information using various communication networks and protocols for sharing information such as electronic messages, user interaction information, engagement metrics, or campaign management resources.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

1. A computer-implemented method comprising:
determining, by one or more servers and based on a plurality of transactions written to a transaction database in response to database events corresponding to one or more electronic payment transactions involving one or more payment accounts, states of a plurality of layers representing fund values associated with the one or more payment accounts according to balances of the plurality of layers of the one or more payment accounts, the database events modifying one or more of the balances of the plurality of layers of the one or more payment accounts in connection with processing the one or more electronic payment transactions involving the one or more payment accounts;
detecting, by the one or more servers, one or more errors in the transaction database resulting from the plurality of transactions via layer checks on the plurality of layers representing the fund values associated with the one or more payment accounts by determining whether the states of the plurality of layers meet expected states according to rules comprising requirements associated with the states of the plurality of layers; and
modifying, in response to detecting to the one or more errors in the transaction database resulting from the database events, one or more database operators associated with the transaction database.

2. The computer-implemented method of claim 1, wherein modifying the one or more database operators associated with the transaction database comprises modifying database application code comprising one or more database storage operators or application programming interface operators in connection with receiving and storing transaction data associated with usage of the one or more payment accounts.

3. The computer-implemented method of claim 1, wherein determining the states of the plurality of layers comprises:
determining one or more transactions corresponding to a layer of the plurality of layers, the layer of the plurality of layers representing funds not yet available, funds authorized but not settled, funds available for spending, an amount of overdraft, a rewards value, a pending credit, authorized but temporarily held funds, or a credit origination; and
determining a state of the layer based on a fund value resulting from the one or more transactions.

4. The computer-implemented method of claim 1, wherein detecting the one or more errors in the transaction database comprises generating the rules comprising the requirements associated with the states of the plurality of layers by:
generating one or more layer relationship rules comprising comparisons of fund values of the plurality of layers; and
generating one or more layer value rules comprising comparisons of individual fund values of the plurality of layers to one or more threshold values.

5. The computer-implemented method of claim 4, wherein detecting the one or more errors in the transaction database comprises:
determining a layer relationship rule comprising a requirement that a first fund value of a first layer of the plurality of layers has a particular relationship with a second fund value of a second layer of the plurality of layers; and
detecting an error in the transaction database in response to determining that the first fund value does not have the particular relationship with the second fund value.

6. The computer-implemented method of claim 1, wherein detecting the one or more errors in the transaction database comprises:
determining one or more transactions of the plurality of transactions that result in the layer checks failing for the plurality of layers; and
determining one or more error categories of the one or more errors based on the one or more transactions.

7. The computer-implemented method of claim 6, further comprising:
determining a transaction chain comprising a set of related transactions including the one or more transactions that result in the layer checks failing for the plurality of layers; and
generating, for display on a client device, an indication of an error of the one or more error categories corresponding to the transaction chain.

8. The computer-implemented method of claim 7, wherein generating the indication of the error comprises:
determining a plurality of correlations between groups of related transaction categories and the one or more error categories; and
determining a cause of the error in the one or more database operators based on the plurality of correlations.

9. The computer-implemented method of claim 7, wherein determining the one or more errors based on the one or more transactions comprises:
determining, based on the error, a value impact on the fund values of the plurality of layers or one or more balances of the one or more payment accounts; and
generating, for display on the client device, a prioritized list of errors comprising the error according to the value impact on the fund values or the one or more balances.

10. A system comprising:
at least one processor; and
a non-transitory computer readable medium comprising instructions that, when executed by the at least one processor, cause the system to:
determine, based on a plurality of transactions written to a transaction database in response to database events corresponding to one or more electronic payment transactions involving one or more payment accounts, states of a plurality of layers representing fund values associated with the one or more payment accounts according to balances of the plurality of layers of the one or more payment accounts, the database events modifying one or more of the balances of the plurality of layers of the one or more payment accounts in connection with processing the one or more electronic payment transactions involving the one or more payment accounts;
detect one or more errors in the transaction database resulting from the plurality of transactions via layer checks on the plurality of layers representing the fund values associated with the one or more payment accounts by determining whether the states of the plurality of layers meet expected states according to rules comprising requirements associated with the states of the plurality of layers; and
modify, in response to detecting to the one or more errors in the transaction database resulting from the database events, one or more database operators associated with the transaction database.

11. The system of claim 10, further comprising instructions that, when executed by the at least one processor, cause the system to modify the one or more database operators associated with the transaction database by:
determining a cause of the one or more errors resulting from a database storage operator or an application programming interface operator in connection with receiving and storing transaction data associated with usage of the one or more payment accounts; and
modifying the database storage operator or the application programming interface operator in connection with processing transactions for the one or more payment accounts.

12. The system of claim 11, further comprising instructions that, when executed by the at least one processor, cause the system to determine the cause of the one or more errors by:
determining correlations between groups of related transaction categories and error categories; and
determining the cause of the one or more errors based on the correlations and a transaction chain comprising a set of transactions associated with the one or more errors in the transaction database.

13. The system of claim 12, further comprising instructions that, when executed by the at least one processor, cause the system to determine the correlations between the groups of related transaction categories and the error categories based on a transaction history of the plurality of transactions in the transaction database and an error history associated with the plurality of transactions in the transaction database.

14. The system of claim 10, further comprising instructions that, when executed by the at least one processor, cause the system to:
generate, for display at a client device, a first interactive report comprising indications of the one or more errors based on one or more states of one or more layers of the one or more payment accounts that fail the layer checks; and
generate, for display at the client device, a second interactive report comprising a summary of transaction chains that correlate to one or more error categories within a previous time period.

15. The system of claim 14, further comprising instructions that, when executed by the at least one processor, cause the system to:
determine, based on instances of transactions in the transaction database corresponding to groups of related transaction categories, value impacts of the one or more errors on the fund values of the plurality of layers or one or more balances of the one or more payment accounts; and
generate, for display with the second interactive report at the client device, a prioritized list of errors comprising the one or more errors according to the value impacts of the one or more errors.

16. The system of claim 10, further comprising instructions that, when executed by the at least one processor, cause the system to detect the one or more errors in the transaction database by:
performing the layer checks on a layer of the plurality of layers based on:
a first rule comparing a fund value of the layer to a threshold value; and
a second rule comparing the fund value of the layer to one or more additional fund values of one or more additional layers of the plurality of layers; and
detecting an error in response to the layer of the plurality of layers failing the layer checks based on the first rule or the second rule.

17. A non-transitory computer readable medium comprising instructions that, when executed by at least one processor, cause a computing device to:
determine, based on a plurality of transactions written to a transaction database in response to database events corresponding to one or more electronic payment transactions involving one or more payment accounts, states of a plurality of layers representing fund values associated with the one or more payment accounts according to balances of the plurality of layers of the one or more payment accounts, the database events modifying one or more of the balances of the plurality of layers of the one or more payment accounts in connection with processing the one or more electronic payment transactions involving the one or more payment accounts;
detect one or more errors in the transaction database resulting from the plurality of transactions via layer checks on the plurality of layers representing the fund values associated with the one or more payment accounts by determining whether the states of the plurality of layers meet expected states according to rules comprising requirements associated with the states of the plurality of layers; and
modify, in response to detecting to the one or more errors in the transaction database resulting from the database events, one or more database operators associated with the transaction database.

18. The non-transitory computer readable medium of claim 17, further comprising instructions that, when executed by the at least one processor, cause the computing device to modify the one or more database operators associated with the transaction database by:
determining, based on the plurality of transactions and the states of the plurality of layers, that a database management application comprises code resulting in the one or more errors; and
modifying the code of the database management application to correct the one or more errors.

19. The non-transitory computer readable medium of claim 17, further comprising instructions that, when executed by the at least one processor, cause the computing device to detect the one or more errors in the transaction database by:
determining a state of a layer of the plurality of layers based on a fund value of the layer according to a balance of the layer; and
detecting, based on the layer checks on the plurality of layers according to the rules, an error in the layer in response to determining that the fund value of the layer is incorrect.

20. The non-transitory computer readable medium of claim 19, further comprising instructions that, when executed by the at least one processor, cause the computing device to:
determine a transaction chain comprising a plurality of transactions resulting in the an incorrect fund value of the layer; and
determine a cause of the error based on a correlation between a group of transaction categories of transactions in the transaction chain and an error category of the error.
